(19) United States
(12) Patent Application Publication
(10) Pub. No.: US 2004/0024914 A1
(43) Pub. Date: Feb. 5, 2004

(54) High performance bit processing engine

(76) Inventors: Raheel Ahmed Khan, Tustin, CA (US); Mahdi Zaidan, Irvine, CA (US)

Correspondence Address: RAHEEL KHAN, # 500, 4590 MACARTHUR BLVD, NEWPORT BEACH, CA, 92660, US

(21) Appl. No.: 10/211,877

(22) Filed: Aug. 5, 2002

(51) Int. Cl. G06F 15/16

(52) U.S. Cl. 709/250; 712/36

(57) ABSTRACT

A high performance bit processing engine that contains various components that are interconnected such that the processing elements are configurable. The same processing element can be used to perform Bit Stripping and later configured for Bit Insertion. The result is a scaleable and flexible engine for processing bits.

### CROSS REFERENCE TO RELATED APPLICATION

I claim the benefit of the filing date of PPA 60/308,403 on Jul. 30, 2001.

### FEDERALLY SPONSORED RESEARCH

Not Applicable

### SEQUENCE LISTING OR PROGRAM

Not Applicable

### BACKGROUND

1. Field of Invention

Communication Protocol Processing

This invention relates to a scaleable and flexible processing engine (PE) for bit manipulation operations.

2. Description of Prior Art

High performance processing engines used in networking and communications applications are typically hard-wired. Software techniques are typically used when programmability/flexibility is required. Software approaches are inherently low performance whereas hardware approaches are inherently inflexible.

Instead of designing a hard-wired fixed function coprocessor, this invention provides a flexible and scaleable alternative that can address a wide range of bit manipulation functions.

### SUMMARY OF INVENTION

This invention describes the Programmable Processing Engine that has a scaleable architecture. Therefore, this architecture can address a wide range of functions: Search for pattern, Bit Stripping, Bit Insertion, Count Pattern, Correlate, Compare etc.

### DRAWINGS

### Drawing Figures

The construction designed to carry out the invention will hereinafter be described, together with other features thereof.

The invention will be more readily understood from a reading of the following specification and by reference to the accompanying drawings forming a part thereof, wherein an example of the invention is shown, and wherein:

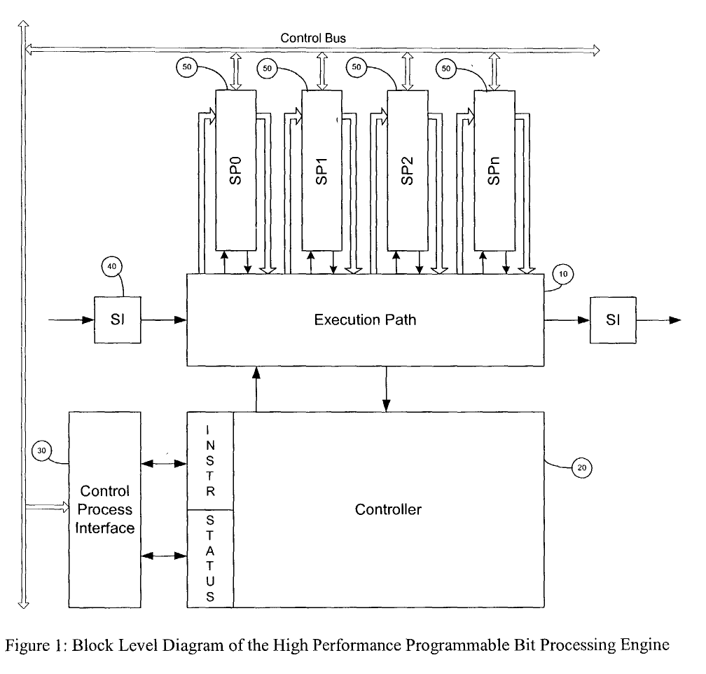

FIG. 1 is a block level diagram of the High Performance Programmable Bit Processing Engine.

### REFERENCE NUMERALS IN DRAWINGS

10 Execution Path
20 Controller
30 Control Process Interface
40 Serial Input
50 Serial Processors

### DETAILED DESCRIPTION

A novel architecture as shown in the FIG. 1 is highly efficient in handling all bit processing operations involved with wireless packet processing. Programmable Processing Elements that have scaleable architecture can address a wide range of functions at high bit rates: Search for pattern, Bit Stripping, Bit Insertion, Count Pattern, Correlate, Compare etc. The architecture consists of an execution path with input and output bit FIFO's and a programmable state-machine. The PE can be configured to perform any of the above mentioned functions on a bit-stream. The Execution Path 10 uses multiple shift registers to give the flexibility of implementing the above operations in a highly optimized manner. The Controller 20 has a Control Processor Interface 30 that allows the PE to act as a programmable coprocessor. The serial input (SI) 40 and serial output (SO) bit FIFO's allow multiples of these PE's to be interconnected allowing the architecture to be scaleable. Once configured and enabled, the PE continues to process the bit stream at its input and put the resulting bit stream in its output FIFO.

The High Performance Bit Processing Engine consists of an Execution block 10, a Controller 20, Control Processor Interface 30, Serial Input 40 and Serial Processors (SP) 50. The Controller does all the instruction decoding and has Instruction and Status Registers. The Serial Processors 50 can be loaded in parallel one at a time through the Control Bus.

From the description above, a number of advantages of this invention become evident:

(a) Highly efficient architecture to handle bit processing operations.

(b) Can handle wide range of functions at high bit rates.

We claim:

1. A high performance bit processing engine with serial processors which are connected to an execution path of a serial input.

2. The closure of claim 1 wherein the said path is managed by a controller that has an instruction and status register interfacing to the control process interface.

3. The closure of claim 1 wherein the said serial processors interface with said control process interface controlling the loading of said serial processors.

4. A configurable architecture with clock speed about the same as data rate.

5. Processing elements that are time shared and can execute arbitrarily complex bit manipulation functions.
